(19) United States
(12) Patent Application Publication
(10) Pub. No.: US 2008/0306764 A1
(43) Pub. Date: Dec. 11, 2008

(54) System and Method for Complex Arena Intelligence

(76) Inventor: Ahuva Weiss-Meilik, Tel Aviv (IL)

Correspondence Address: EMPK & Shiloh, LLP;c/o Landon IP, Inc., 1700 Diagonal Road, Suite 450, Alexandria, VA, 22314, US

(21) Appl. No.: 11/795,125

(22) PCT Filed: Dec. 18, 2005
(86) PCT No.: PCT/IL05/01355

§ 371 Date: Jun. 12, 2008

Related U.S. Application Data
(60) Provisional application No. 60/636,102, filed on Dec. 16, 2004.

(51) Int. Cl. G06Q 10/00; G06F 11/34

(52) U.S. Cl. 705/2

(57) ABSTRACT

The present disclosure generally relates to a method and system for processing and assessing health care-related data. A system and method are provided for evaluating and/or analyzing and/or predicting performance and outcome of a health care service provider. The system and method may enable standardization of generic health care organization data, calibration of the data, and usage of the data to provide performance indications and technology assessments on a per unit and/or organizational level.

### FIELD OF THE DISCLOSURE

The present disclosure generally relates system and method for the assessment and evaluation of complex arena such as health care-related service providers. A system and method are provided for evaluating and/or analyzing and/or predicting performance and outcome of a health care service provider.

### BACKGROUND

Health care service providers, for example physicians, hospitals or hospital consortiums, medical aid companies and the like, generally have an access to large amounts of medical related data of their patients. Typically, the medical data of the patients is handled and used on individual basis. The medical data is generally collected by staff members to enable relevant staff members to view personal details of a patient, such as patient profiles, histories, medical-related expenses, and so on. Such data typically resides in dispersed autonomous medical systems that do not share medical data. Due to the autonomous nature of medical systems and to the diversity of the data formats used by them, whenever a medical treatment is to be given to a patient, such data are very difficult, and sometimes impossible, to collect and organize.

Therefore, although many patients may have had medical condition similar to the current condition of a patient to whom a treatment is to be given, it is almost impossible for the service provider rendering the medical treatment to effectively generate and use comparative data which is based on the medical experience of these patients. This difficulty often leads to medical and administrative difficulties and, therefore, to medical and administrative inefficiency.

Consequently, public hospitals can usually provide only poor predictions or evaluations regarding a medical treatment given to a patient. An improved prediction and evaluation capability would help guiding health care service providers into taking more accurate and suitable steps that would improve the efficiency of both the administrative and medical aspects of a treatment.

The main goal of any organization is to achieve quality and excellence. In reality there still is a wide gap between the current status and achieving this goal. A dominant factor responsible for this discrepancy is the lack of information concerning clinical performance and outcome from the clinical “production floor”, due mainly to the high level of complexity of the medical field and the fact that it's conduct is not linear. Current tools and methods are far from giving the answer to the need for interactive solution for clinical arena intelligence.

### SUMMARY

The following embodiments and aspects thereof are described and illustrated in conjunction with systems, tools and methods, which are meant to be exemplary and illustrative, not limiting in scope. In various embodiments, one or more of the above-described problems have been reduced or eliminated, while other embodiments are directed to other advantages or improvements.

As part of the present disclosure a system is provided for the assessment of the performance and outcome of a health care service provider, the system may include a database for storing health care related data wherein the database comprises data collected from the production floor of a health care service provider, a processor adapted to perform a linearization of at least a section of the data collected from the production floor of the health care service provider by using a filter system and an output module adapted to output information according to selected criteria.

As part of the service provider, performing linearization of at least a section of the data present disclosure a method is provided for assessing the performance and outcome of a health care service provider, the method may include providing health care related data, wherein the data comprises data collected from a production floor of a health care collected from the production floor by using a filter system and producing information according to selected criteria.

### BRIEF DESCRIPTION OF THE FIGURES

Exemplary embodiments are illustrated in referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1A is a schematic block diagram of a system for enabling evaluation of performance of a health care service provider, according to some embodiments of the present disclosure;

FIG. 1B is a schematic block diagram of a network based system for enabling evaluation of performance of a health care service provider, according to some embodiments of the present disclosure;

FIG. 2A is a flowchart illustrating a method, according to some embodiments of the present disclosure;

FIG. 2B is a flowchart illustrating a method, according to some embodiments of the present disclosure;

FIG. 3 is a is an illustration of an example of an interface for entering in data related to a diagnosis of pneumonia, according to an embodiment of the present disclosure;

FIG. 4 is an illustration of an example of an interface for entering data related to a diagnosis of a vascular graft infection, according to an embodiment of the present disclosure;

FIG. 5 is an example of an interface according to which a deviation assessment may be made for a selected treatment, according to some embodiments of the present disclosure;

FIG. 6 is an example of a table according to which a patient risk score may be derived, according to an embodiment of the present disclosure; and

FIG. 7 is an exemplary layout of interactive display for submitting queries and displaying results to the queries, according to some embodiments of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION OF THE FIGURES

The following description is presented to enable one of ordinary skill in the art to make and use the disclosure as provided in the context of a particular application and its requirements. Various modifications to the described embodiments will be apparent to those with skill in the art, and the general principles defined herein may be applied to other embodiments. Therefore, the present disclosure is not intended to be limited to the particular embodiments shown and described, but is to be accorded the widest scope consistent with the principles and novel features herein disclosed. In other instances, well-known methods, procedures, and components have not been described in detail so as not to obscure the present disclosure.

Unless specifically stated otherwise, as apparent from the following discussions, it is appreciated that throughout the specification discussions utilizing terms such as “processing”, “computing”, “calculating”, “determining” and the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

The platforms, processes and displays presented herein are not inherently related to any particular computer or other apparatus. Various general-purpose computing systems and networking equipment may be used with programs in accordance with the teachings herein, or it may prove convenient to construct a more specialized apparatus to perform the desired method. The desired structure for a variety of these systems will appear from the description below. In addition, embodiments of the present disclosure are not described with reference to any particular programming language. It will be appreciated that a variety of programming languages may be used to implement the teachings of the present disclosure as described herein.

As part of the present disclosure a system is provided for the assessment of the performance and outcome of a health care service provider, the system may include a database for storing health care related data wherein the database comprises data collected from the production floor of a health care service provider, a processor adapted to perform a linearization of at least a section of the data collected from the production floor of the health care service provider by using a filter system and an output module adapted to output information according to selected criteria.

According to some embodiments, the processor may further be adapted to perform an analysis of at least a section of the linearized data.

According to some embodiments, the processor may further be adapted to perform an analysis of at least a section of the linearized data in combination with at least a section of the health care related data.

According to some embodiments, the processor may further be adapted to produce a response to a query.

According to some embodiments, the processor may further be adapted to perform a simulation for a selected scenario.

According to some embodiments, the processor may further be adapted to perform a prediction of a selected scenario.

According to some embodiments, the processor may further be adapted for use by a remote user. According to some embodiments, the processor may further be adapted to function on a real time basis. According to some embodiments, the processor may further be adapted to function on retrospective basis. According to some embodiments, the processor may further be adapted to function interactively.

As part of the present disclosure a method is provided for assessing the performance and outcome of a health care service provider, the method may include providing health care related data, wherein the data comprises data collected from a production floor of a health care service provider, performing linearization of at least a section of the data collected from the production floor by using a filter system and producing information according to selected criteria.

According to some embodiments, the database may include, clinical data (for example, laboratory dada, x-ray data and the like), financial data, data relating to service (for example, satisfaction from service, quality of service and the like), logistical data, data relating to human resources, administrative data, sanitation data or any combination thereof.

According to some embodiments, the linearization may include generation of a clinical identity of a patient, process information, performance information, process information, outcome information or any combination thereof.

According to some embodiments, the linearization may include evaluation of the correlation, association, relationship or any combination thereof between and/or within any of the components of the production floor. According to other embodiments, the linearization may be associated with at least at a part the health care related data.

According to some embodiments, the method may further include performing an analysis of at least a section of the linearized data. In another embodiment, the method may further include performing an analysis of at least a section of the linearized data in combination with at least a section of the health care related data.

In another embodiment, the analysis may be performed within and/or between one-dimensional, multidimensional, one-perspective, multi-perspective, high-resolution parameters or any combination thereof.

In another embodiment, the analysis may include analysis of clinical data, which may include clinical decision-making and any clinical process (for example, medical treatment).

In another embodiment, the analysis may further include analysis and integration of financial data, data relating to service, logistical data, data relating to human resources, administrative data, sanitation data or any combination thereof.

In another embodiment, the analysis may include a cause-effect analysis. In another embodiment, the analysis may include an analysis of clinical process applied to patients with similar clinical identities.

According to some embodiments, the method may further include producing a response to a query.

According to some embodiments, the method may further include performing a simulation to a selected scenario. In another embodiment, the scenario may be a clinical, economical, service scenario or any combination thereof.

According to some embodiments, the method may further include evaluating current performance, current outcome, former performance, former outcome or any combination thereof. In another embodiment, evaluating may include evaluating a patient's clinical process.

According to some embodiments, the method may further include performing a prediction of future performance, future outcome or both.

According to some embodiments, the filter system comprises a one-dimensional, multidimensional, one-perspective, multi-perspective, high-resolution parameter filter or any combination thereof.

According to some embodiments, the information comprises a one-dimensional, multidimensional, one-perspective, multi-perspective, high-resolution parameter types of information or any combination thereof.

According to some embodiments, the updating the health care-related data.

According to some embodiments, the method may further include calibrating, scaling, normalization or any combination thereof of the health care-related data.

According to some embodiments, the method may further include producing a report, wherein the report includes at least a part of the information.

The term “production floor” may refer, according to some embodiments, to any front line between a patient and any member the health care service provider's personnel or any health care professional, for example physician, nurse, physiotherapist and others. In another embodiment, the term “front line” may refer to any location, event, scenario and the like, wherein medical related (for example clinical) decisions can be made. According to some embodiments, the production floor may be a complex production floor which cannot be described in a linear form. According to some embodiments, the production floor may be a semi-chaotic production floor.

The term “performance information” may relate, according to some embodiments, to anything that has been done in relation to the health care provider (for example, any clinical, administrational, financial actions and others). The term “outcome information” may relate, according to some embodiments, to any result that was obtained in relation to the health care service provider (for example, any clinical, administrational, financial results and others).

According to some embodiments, the term “clinical identity” may refer to a specific combination of demographic data and medical data of a patient. The demographic data may include, for example, the name, age, gender, socioeconomic state and address of the patient. The medical data may include, for example, medical symptoms or signs, primary (or general) clinical diagnosis, such as the type and severity of the patient's illness, past surgical procedures (if relevant), co-morbidity, survival odds, complications odds and so on. Different clinical identities (sometimes referred to herein as “clinical profile”) may be formed for a given patient, depending on issued queries. For example, issuing of a query may result in a clinical identity that includes the gender and illness type of a patient. According to another example, issuing of a different query may result in a clinical identity that includes the patient's age, illness type and severity and past hospitalizations. According to some embodiments, data from one or more data sources may be aggregated in response to an issued query, to form, or generate, a requested clinical identity for a patient. According to other embodiments, data from one or more data sources may be aggregated to form, or generate, a requested clinical identity for a patient regardless of a query.

According to some embodiments, the term “health care-related data” may refer to raw demographic data and raw medical data that may be stored in, and collected from, a plurality of data sources.

According to some embodiments, the terms “filter”, “filter system” or “filtering tools” may refer to any computer program that is able to identify or detect a subgroup within a group, wherein the members of the subgroup have at least one common attribute (such as, but not limited to, patient's age, gender, medical condition, medical treatment, diagnosis, date of admission, outcome and more).

According to some embodiments, the terms “selected criteria” may refer to any standard or measure upon which a decision or evaluation may be based.

According to some embodiments, the term “linearization” may refer to any mechanism (such as filters) that enables the assessment and evaluation of complex arena (such as health care service provider's production floor). According to some embodiments, linearization may be performed according to http://www.cs.indiana.edu/˜febertra/mxn/parallel-data/, which is incorporated by reference.

In one embodiment, the term “perspective” may refer to any point of view by which the health care service provider can be assessed. Non-limiting examples of different perspectives are: clinical, economical (financial, logistical), administrative, service and human resources.

In one embodiment, the term “dimension” or “dimensional” may refer to category which may include, for example, time, the organizational unit, age, gender, type of medical treatment and others.

In one embodiment, the term “high resolution parameters” may refer to category which may include, for example, any single detail related to the health care service provider or the patient.

According to some embodiments, the term “query” may generally refer to a demand for medical data of specific interest. For example, a query may be issued, for example by a physician, to get a list of patients, all of whom are women between the ages 20 and 30 that suffered from stomach aches, were operated on a certain organ and their survival probability were around 88% at the beginning of their medical treatment. Pursuant to the later example, depending on the actual embodiment, such a query may cause, at a first phase, the generation of these women's clinical identities, and then, at a second phase, the query may promote a required analysis of the clinical identities.

According to some embodiments, the term “simulator” may generally refer to any mean allowing testing some real-world practical scenario. Simulation, may use a simulator or otherwise experimenting that may demonstrate the eventual real effects of some possible conditions. The simulation may, for example, assist in selecting therapeutic and diagnostic procedures or in any other clinical or non-clinical (financial, administrational and so on) decision-making.

According to some embodiments, the term “cause-effect” may refer to any essay that may concern with why things happen (causes) and what happens as a result (effects).

Embodiments of the present disclosure may enable evaluating and predicting performance of health care service providers, such performance may relate to the type of treatment that is recommended or existing for a patient, and the costs involved in the recommended treatment. Health care service providers such as hospital, doctor, dentist, office, clinic, nursing home, medical aid company or others may utilize a data taken from patient records, medical records, patient surveys, cost data and so on, run formulas on it, create information or analyze the data. Other embodiments may use the data taken from patient records, medical records, patient surveys, cost data etc. for providing performance evaluations of treatment or providing performance predictions for a group of patients. Such treatment can be provided to a group of patients. A group of patients can be for example; on the level of a department, organization, region and so on. Such analysis may enable, for example, a health care provider to automatically determine efficiencies or inefficiencies in the provision of services, for example, performing a laparoscopic surgery in comparison to an open surgical procedure.

Further, a health care service provider, for example, may use data from multiple patients, grouped according to selected criteria, to analyze or generate information on multiple patient data, recovery, success or ongoing medical data, service provision data, laboratory data, satisfaction data, cost or economic data etc. thereby generating department or organizational-wide trends and preferable paths of action etc. to raise organizational or departmental levels of efficiency, service, safety, clinical outcome, etc. The input data may be in multiple data and physical formats, possibly being a data which is collected and stored in different manners and in different locations.

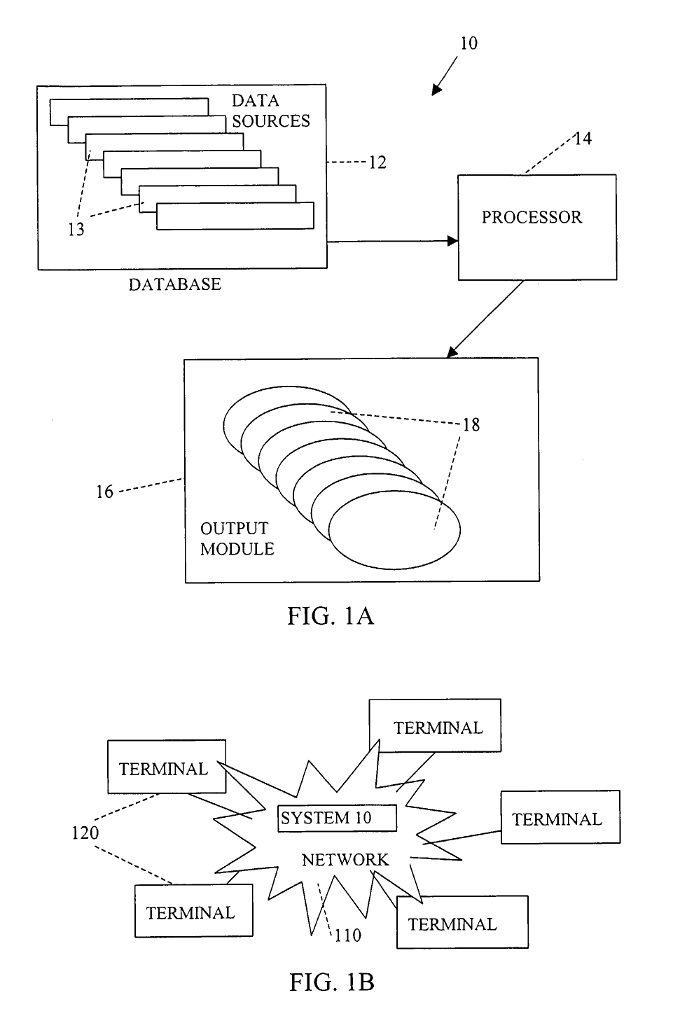

Reference is now made to FIG. 1A which is a schematic block diagram illustration of a system for enabling health care service provider data collection and analyses, according to some embodiments of the present disclosure. As can be seen in FIG. 1, system 10 may include one or more database(s) 12 of computerized patient records. Database 12 may include data from multiple data sources 13, which may be aggregated or otherwise combined into a central database. In one example, a database may represent all the data entered into system 10. The data may be divided into sections, variables or categories, for example, each section may represent a selected data source 13, which may be entered into system 10 according to any suitable means.

System 10 may include a processing engine 14, which may include one or more data processing tool(s), to enable processing of data in database 12. For example, processing engine 14 may run one or more queries or sub-routines that may process data in one or more sections or subsets of the data, and may provide results according to selected criteria. For example, each data type (e.g., data from a laboratory, an emergency room, a questionnaire, operating theater, patient record, etc.) may be processed by one or more sub-routines, and the results from the initial processing may be aggregated or standardized in database 12.

System 10 may include one or more output components 16, for example, a terminal, monitor, speaker, printer etc. to output results of the data processing. For example, system 10 may output the results in one or more selected information 18. Of course, other structures and dimensions may be used. In some embodiments the centralized database or multiple databases may be physically diverse. In some embodiments data processing tool 14 may be one or more tools, for example, a set of workstations or personal computers each operating local software, or a central server operating software accessed by terminals, for example, web browsers.

Reference is now made to FIG. 1B, which illustrates a network oriented data collection and analyses system 10, which may be implemented in a data network 110, for example, an Intranet, Extranet or the Internet. System 10 may be accessed or operated from one more terminals 120 connected to network 110.

According to an embodiment of the present disclosure, database(s) 12 may include, for example, one or more patient registries or medical records, financial data, costing system data including types of treatments, costs of treatments etc., laboratory data and administrative data, including dates of admission and release, dates and times of treatments etc. In some embodiments patient data from blood banks, imaging departments, surveys, questionnaires, logistics systems or other data sources may be used. Of course, other patient data sources may be used. Data in addition to patient data, such as cost or other data unrelated or disconnected from specific patients, may be included in database(s) 12. According to some embodiments of the present disclosure, non-objective patient data may be included, for example, data from satisfaction surveys, or other suitable sources. Data from such sources may be entered directly into database 12, or may be extracted from handwritten or other sources and added to database 12.

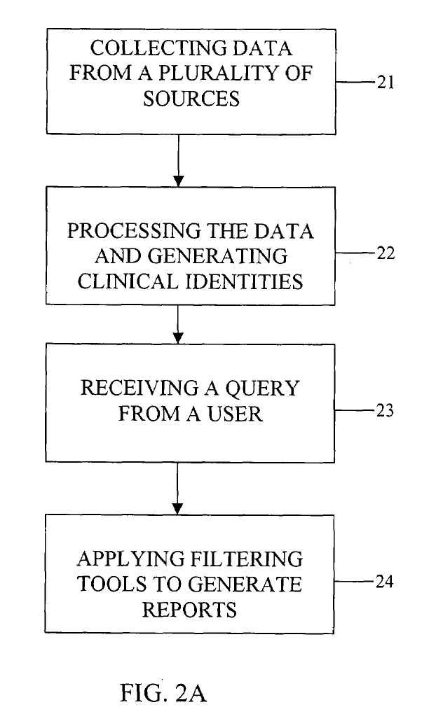

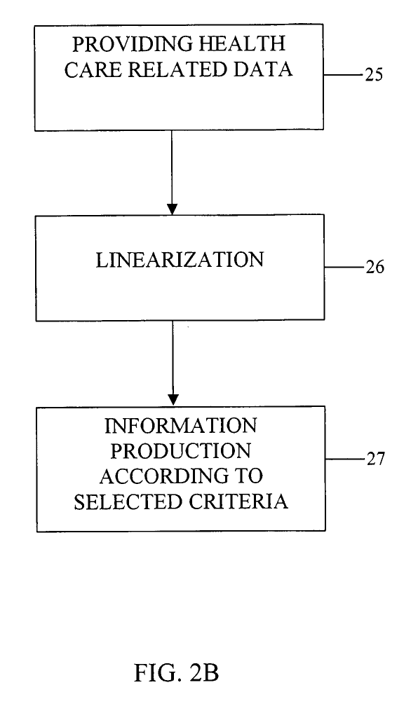

Reference is now made to FIG. 2A, which schematically illustrates an example of a series of operations or processes that may be implemented to assess, evaluate performance and outcome, simulate performance and outcome, predict performance and outcome of a health care service provider. At block 21, data may be collected from a plurality of data sources. For example, data may be collected from one or more medical or health care data, financial data and patient response data at a health care organization. Medical data may be collected, for example, from one or more of patient registries, laboratories, administrative databases, operating theaters, blood banks, imaging departments, rounds duty rosters, etc. Financial data may be collected, for example, from costing systems or other cost measuring systems. Patient response data may, for example, be collected from one or more of surveys, questionnaires, or other satisfaction measuring mechanisms, etc. Data from one or more sources may be aggregated and standardized into at least one format on which queries may be run using known or specifically designed data aggregation software tools.

At block 22 the collected data may be processed, for example by using one or more aggregation tools, standardization tools, calibration and/or scaling tools, selected algorithms and/or analyzing tools etc., to enable generation of clinical identities per patient, per population, or per group basis. A clinical identity may be defined, for example, as a category or type of patient, as defined according to the patient's conditions, history, and/or treatment plan etc. A clinical identity may be used, for example, to filter a set of patients, or to create a query based on a subset or a category of patients, for example age, prognosis, diagnosis, outcome, cost, budget, and so on. For example, a patient may be assigned a clinical profile or identity that may include a selected risk profile, disease profile, gender, age, admission date, and/or urgency profile etc. The assignment of a clinical identity to a patient may be indicative of the causes of a patient's condition and, as such, they may assist the health care organization to appropriately deal with the causes. For example, a clinical identity may be indicative of elements that may have caused a certain infection or other condition. A group may be defined, for example, on an organizational level, departmental level, or on other suitable level. In order to provide such clinical identities, the computer system may run one or more queries on the collected data, for example to analyze the data according to selected data segments or data subsets to provide, for example, case-mix characteristics. “Case mix” describes the level of service needed for the purpose of setting a daily medical care rate.

According to some embodiments of the present disclosure, the generic data in a health care organization computer system may be broken down or isolated into component parts, thereby providing single dimensional or linear data relating to services and procedures provided by such a health care organization. For example, in contrast to typical service providing units (e.g., an operation theater, wherein the theater is connected with multiple other facilities, staff, departments, etc.), system 10 may run queries to enable automatic-generalization of data related to selected or isolated features within the service provided. For example, the data from a surgery theater for a particular procedure may be separated into micro units including time spent in surgery, blood units required, cost of anesthetic agents used, staff hours used, etc. The implementation of an analysis that may include one or more of such micro units may enable the performance and service provided at the patient level to be automatically analyzed at the group, departmental and/or organizational level.

According to some embodiments of the present disclosure, one or more calibration, scaling and normalization tools may be used to compare treatments or procedures with selected standards, to indicate the relative performance levels achieved. For example, results of a treatment provided to an individual patient or group of patients may be compared to a standard for similar treatments, to help determine on an individual, group, or organizational level etc., the performance level for such a treatment.

In some embodiments, for example, tools used may include parametric and non parametric analytic statistical methods, Statistic Process Control (SPC), Paretto calculation, descriptive statistics, parametric methodologies, POSSUM scale (Physiological and Operative Severity Score for the enUmeration of Mortality and morbidity), Evidenced Based Medicine (EBM) tools, or other suitable analyzing tools, to provide indications of performance. For example, indications may thereby be provided that relate to expected patient costs, procedure outcome, morbidity, mortality, patient satisfaction, etc. for selected procedures, operations etc. Other algorithms, formulas and/or scales that may be used include GCS, Euroscore, PRISA, Asthma severity assessment, Vascular score, Hunt-Hess, Marshal score, TIMI for UA-NSTEMI, TIMI for STEMI, NYHA, CCS, Killip, Charlson, Lansky, Karnofsky, ECOG etc.

In some embodiments, for example, data gathered from an admitted patient may be compared to data from previously admitted and/or treated patients to help determine expected performances, costs, service levels etc. by comparing treatments applied to patients with similar characteristics.

In one embodiment, for example, each patient upon admittance to the health care services provider may have relevant data entered into the system database. According to the patient's medical history, characteristics, conditions etc. the computer system may generate a profile of the patient based on the performance of previously admitted patients with similar characteristics.

In some embodiments the patient profile may include, for example, score based feedback including expected trends associated with the patient's conditions, optional treatment paths and the probabilities of success, costs, risks, hospitalization durations etc. associated with the patient's conditions etc. Calculation of clinical profiles per patient may utilize customized and/or known formulas or tools. In this way the system may provide simulation tools, for example, “What-If” scenarios, for example, if x treatment is provided to y category patient, z results may be anticipated. Other simulation tools may be used to process the system data to provide causes and/or effects for selected scenarios.

At block 23, the system may accept a query from a user, for example, a generic or specific query to analyze or otherwise filter the data. For example, a query may include running an analysis on a segment or subset of data (e.g., a segment of the population, treatment cost, treatment outcome, etc.). In another example a specific query may be executed, for example, on the specific patient outcome, cost, treatment data, etc. In some embodiments a query may include a first filtering step where, for example a subset of patients or subset of data is requested (e.g., patients of a certain age, severity of illness, type of illness, cost of treatment, etc), and a second step where for example a specific query is requested (e.g., asking for certain data from patients or results from the first query, asking for certain analysis or processing of the data, etc.).

At block 24 the results of a query may be further processed by filtering tools to enable generation of information. In some embodiments information may be generated according to one or more subsets or segments, for customized purposes. For example, a head of a surgery department may request generation of information that may includes all patients in a pre-selected period that were operated, that underwent selected surgical, and maybe other, procedures, were treated by a selected staff member or the condition of whom deteriorated into a selected status etc. According to other examples, the information may be generated according to departments, on an organizational level, or on other suitable levels or scales. More specific information may be generated according to population or other suitable segments, for example, country of birth, family status, socio-economic status, level of education, gender, age, admission/release date, diagnosis, initial severity of condition, success of recovery, or any other suitable groupings. In some embodiments information may be, for example, generated according to a subset of selected diseases or conditions etc. Any combination of the above steps may be implemented. Additionally, or alternatively, other, steps or series of steps may be used.

According to one embodiment of the present disclosure, one or more formulas may be provided for determining morbidity trends of an individual patient or a group of patients. For example, information may be generated to introduce aggregated performance for individuals, segments of individuals, departments, organizations, nations etc., for selected procedures and treatments etc.

According to some embodiments of the present disclosure, a selected medical treatment method or scenario may be assessed based on data in database 12. In one example, an expected mortality rate or trend (R1) of an individual patient or group of patients undergoing a selected treatment path or method may be calculated by, for example:

Logₑ R1/(1−R1)=−7.04+(0.13*Physiological Score)+(0.16*Operative Severity Score).

Other formulas may additionally or alternatively be used.

In another example, an expected morbidity rate or trend (R2) may be calculated for an individual patient or group of patients in relation to one or more treatment paths or methods, for example, using:

Logₑ R2/(1−R2)=−5.91+(0.16*Physiological Score)+(0.19*Operative Severity Score).

Other formulas may additionally or alternatively be used.

Reference is now made to FIG. 2B, which schematically illustrates a general example of a series of operations or processes that may be implemented to assess, evaluate performance and outcome, simulate performance and outcome, predict performance and outcome of a health care service provider. for example. At block 25, health care related data may be provided, wherein the data may include data collected from a production floor of a health care service provider (for example, certain clinical process that was performed in the operation theater or the outcome of this process). At block 26, linearization of at least a section of the data collected from the production floor may be performed by using a filter system. At block 27, information may be producing according to selected criteria.

In some embodiments system 10 may enable automated technology assessments to be implemented for one or more devices, units of equipment, service provision resources etc. For example, a query may be run for one or more types of procedures that were executed using one or more selected devices or units of equipment, to generate an indication or assessment as to the efficiency, reliability, risk, usage cost, maintenance cost, service level, operation time etc. of the device(s) or unit(s) of equipment. In one example a query may be run on one or more types of procedures that utilized selected health care service facilities, to provide an indication as to the effectiveness, efficiency, service level etc. provided by the respective facilities.

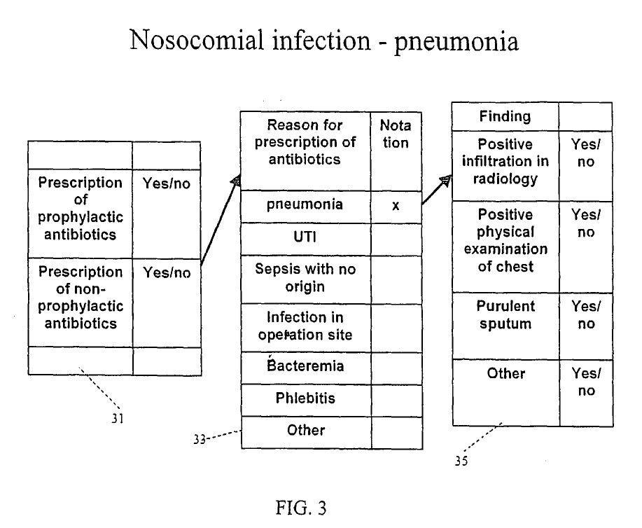

According to one embodiment of the present disclosure, a formula may be provided for determining infectious trends of an individual patient or group of patients. In one example, as can be seen with reference to FIG. 3, an interface may be provided to collect data useful in determining trends relating to, for example, Nosocomial infections (Pneumonia); other conditions may be similarly analyzed. For example, clinical process (for example, medical treatment) data may be entered into a database via an interface that enables entry of data relating to patient conditions and/or treatments undergone. As shown in FIG. 3, data fields required may include fields related to the prescription of antibiotics 31, reasons for the prescription 33, and the findings following the application of antibiotics 35.

In one embodiment an algorithm may run on the data shown in FIG. 3, to provide performance and outcome assessment or, in some cases, (automated) diagnosis of a patient's condition. For example, such an algorithm may include:

if 72 hours or more have passed since a patient's admission to hospital AND the patient has undergone an atelectasis elimination AND (the patient has undergone a positive physical examination of the chest OR a positive infiltration in radiology has been determined) AND (there is purulent sputum OR a positive blood culture OR a positive sputum culture), then pneumonia is diagnosed. Other scenarios, factors, variables and formulas may be used. Such methods may be applied to other diseases or conditions.

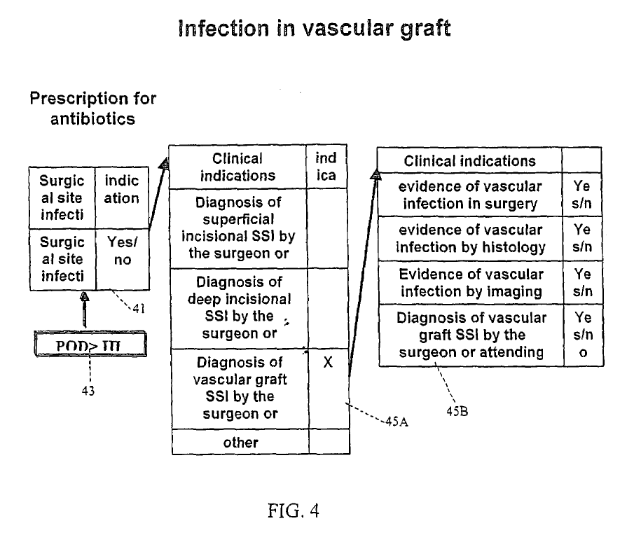

In another example, as can be seen with reference to FIG. 4, an interface may be provided to collect data useful in determining trends relating to vascular graft infections. For example, clinical process data (for example patient treatment data) may be entered into a database via an interface that enables entry of data relating to patient conditions and/or treatments rendered to the patient. As shown in FIG. 4, data fields may include, for example, fields related to the prescription of antibiotics 41, postoperative day (“POD”) values 43, and various clinical indications 45A and 45B. Of course, other data-specific fields may be used and other diseases or conditions may be processed to meet specific needs the health care service provider.

In one embodiment an algorithm may be run on the data entered in FIG. 4, to help provide an automated diagnosis of a patient's condition. For example, such an algorithm may include:

If implantation of vascular graft surgery was performed AND (either there is evidence of vascular infection in surgery OR there is evidence of vascular infection by histology OR there is evidence of vascular infection by imaging OR there are recurring positive blood cultures without other infectious origins OR there is isolation of a microorganism from a removed blood vessel OR there is a diagnosis of vascular graft SSI by the surgeon or attending physician), then an infection in vascular graft is diagnosed. Other scenarios, factors, variable and

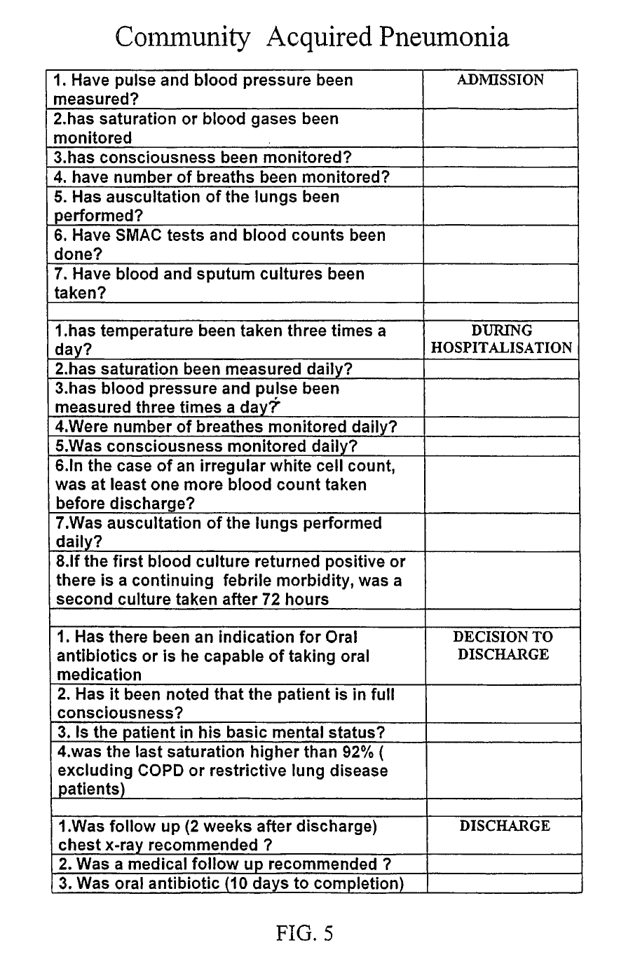

According to some embodiments of the present disclosure, as can be seen with reference to FIG. 5, an indication of deviation of performance from best practice may be calculated. FIG. 5 illustrates a patient's admission and follow-up form which may be filled-in as part of the data collection step 21 of FIG. 2A. collecting data of a patient other examples can illustrate an actual treatment of an individual or a segment or group and may be assessed relative to a scale in which the best practice or “ideal” treatment/Process is represented. In one example, as can be seen in FIG. 5, the actual treatment of Community Acquired Pneumonia may be compared to the best practice for treating such pneumonia. According to one embodiment, such a comparison may be based on an analysis of procedures executed during admission (501) and hospitalization (502), and on decision relating to patient discharge (503) and patient discharge (504). The results of such an analysis may enable a performance score to be generated according to, for example, a doctor or other staff member, department, hospital or organization, treatment method, equipment used, population segment etc. Other factors and variables may be used for performance deviation assessments related to Community Acquired Pneumonia and/or other conditions, diseases, treatments etc.

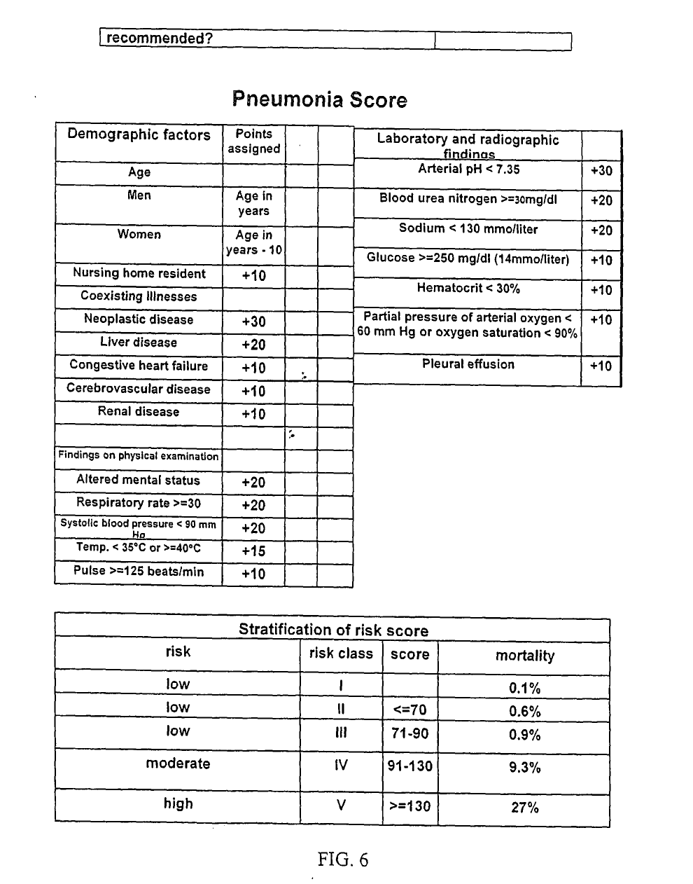

According to some embodiments of the present disclosure, as can be seen with reference to FIG. 6, system 10 may enable calculation of patient's scores (risk class, the patient's expected mortality/survival rate) based on points assigned according to Demographic factors (601), for example, age, gender, related diseases occurred in the past, clinical parameters such as temperature, blood pressure, respiratory rate, etc. Points are also assigned according to Laboratory and radiographic findings (602), for example, arterial pH, amount of glucose in the blood, percentage of hematocrit, etc. Table (603) displays Stratification of risk score which sorts the risk level (classified as low, moderate and high), risk classes according to the total points assigned (this is the score), all of which results in expected mortality rate. Thereby providing valuable information for a medical establishment and helps in providing a wider picture of a patient. As an example, a women at the age of 32 will assign 22 points according to the formula, according to her health care history she suffered from a liver disease in the past, therefore she will assign 20 points more, her arterial pH in 6 therefore she will assign 30 points more, resulting in a score of 72. The next step is looking at table (603) which defines the score of 72 to be a low risk and 0.6% mortality. The illustrated tables of FIG. 6; (601), (602) and (603) display data related to a patient's health care, however such a display is not limited according to the examples in FIG. 6, it is to say that the tables can be amended according to a specific need or a better format created in the future.

According to some embodiments an algorithm may run on the above entered data to provide a risk score on a per patient or group level. In one example patients may be classified according to their risk class, and a mortality or other prognosis may be provided for the various risk classes. Such prognosis may be, for example, compared with admission rates of patients, to provide score for, for example, the number of low risk patients out of the number of admissions with pneumonia, to help assess the effectiveness of the admissions procedure. Other variables, prognosis, methods, segments etc. may be used

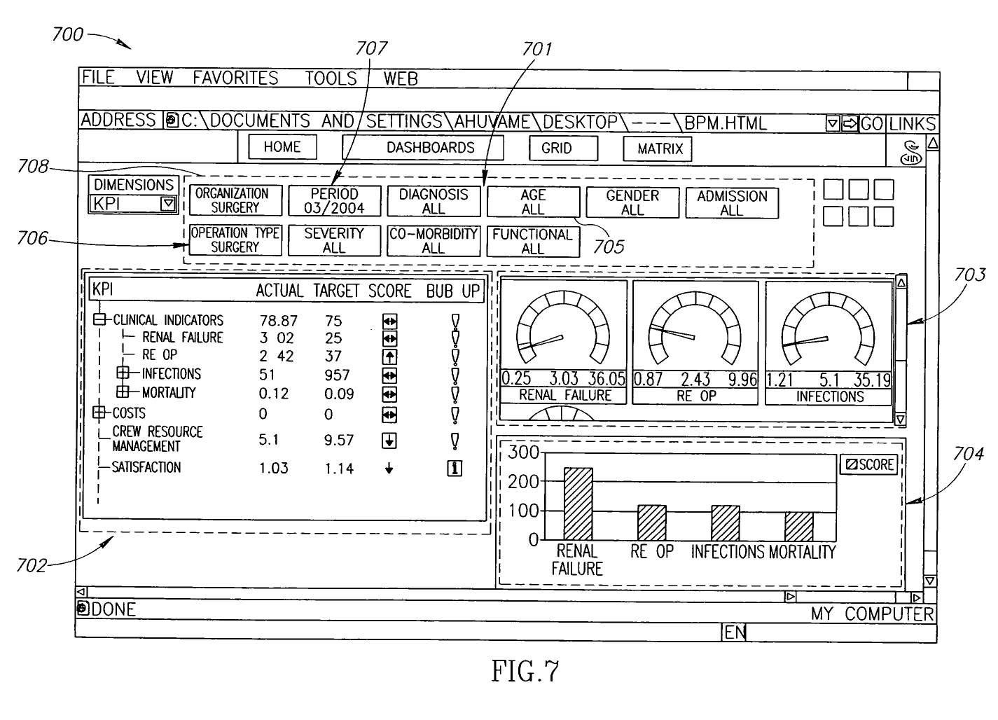

According to some embodiments of the present disclosure, as can be seen with reference to FIG. 7, system 10 of FIG. 1 may include an interactive display, such as display 700, for submitting queries and displaying to an operator of the system results of health care-related prognosis, for example. An easy-to-use drop-down menu (701) allows an operator of the system to submit queries. A query may be submitted as described hereinafter.

Menu 701 may consist of, say, ten category-wise push buttons (for example), each of which may be “clicked” by an operator (a physician, for example) to allow entering data in the respective category, the entered data being part of a query. For example, by clicking on the age push-button (705), ages from 1 to 120 (for example) may appear (on a different or new display window) and the age of the patient (48, for example) may be entered by a physician as part of the query. The query may be enhanced by entering additional data. For example, by clicking on the operation type menu 706, the system's operator may enter history surgical procedures of the patient. The query may be further enhanced by entering data in additional categories. For example, by clicking the period category 707 the operator may enter previous illness periods, and so on, of the patient.

The system may respond to a query by outputting evaluations, predictions, estimations and the like, which the system may display in several (for example, in three) formats (702, 703 and 704). Format 702 displays detailed results with all the relevant information to make an accurate assessment, whereas formats 703 and 704 display the results in different graphical manners, for facilitating faster and clearer diagnosis, for example.

Information produced according to embodiments of the disclosure may be partially or completely presented as a report. The information may relate, for example, to the evaluation of the performance and/or outcome of the health care provider, the success rates of a certain medical process (for example treatment) to a patient and more.

While a number of exemplary aspects and embodiments have been discussed above, those of skill in the art will recognize certain modifications, permutations, additions and sub-combinations thereof. It is therefore intended that the following appended claims, and claims hereafter introduced, be construed as including all such modifications, permutations, additions and sub-combinations as are within their true spirit and scope.

What we claim is:

1. A system for the assessment of the performance and outcome of a health care service provider, the system comprising:
a database for storing health care related data wherein said database comprises data collected from the production floor of a health care service provider;
a processor adapted to perform a linearization of at least a section of said data collected from the production floor of the health care service provider by using a filter system; and
an output module adapted to output information according to selected criteria.

2. The system of claim 1, wherein said database comprises, clinical data, financial data, data relating to service, logistical data, data relating to human resources, administrative data, sanitation data or any combination thereof.

3. The system of claim 1, wherein said linearization comprises generation of a clinical identity of a patient, performance information, process information, outcome information or any combination thereof.

4. The system of claim 1, wherein said linearization comprises evaluation of the correlation, association, relationship or any combination thereof between and/or within any of the components of the production floor.

5. The system of claim 1, wherein said linearization is associated with at least at a part the health care related data.

6. The system of claim 1, wherein said processor is further adapted to perform an analysis of at least a section of the linearized data.

7. The system of claim 6, wherein said processor is further adapted to perform an analysis of at least a section of the linearized data in combination with at least a section of the health care related data.

8. The system of claim 6, wherein said analysis is performed within and/or between one-dimensional, multidimensional, one-perspective, multi-perspective, high resolution parameters or any combination thereof.

9. The system of claim 8, wherein said analysis comprises analysis of clinical data.

10. The system of claim 9, wherein said analysis further comprises analysis and integration of financial data, data relating to service, logistical data, data relating to human resources, administrative data, sanitation data or any combination thereof.

11. The system of claim 1, wherein said analysis comprises a cause-effect analysis.

12. The system of claim 1, wherein said analysis comprises analysis of clinical process applied to patients with similar clinical identities.

13. The system of claim 1, wherein said processor is further adapted to produce a response to a query.

14. The system of claim 1, wherein said processor is further adapted to perform a simulation for a selected scenario.

15. The system of claim 9, wherein said scenario comprises a clinical, economical, service scenario or any combination thereof.

16. The system of claim 1, wherein said processor is adapted to perform a prediction of a selected scenario.

17. The system of claim 1, wherein said filter system comprises a one-dimensional, multidimensional, one-perspective, multi-perspective, high-resolution parameter filter or any combination thereof.

18. The system of claim 1, wherein said information comprises a one-dimensional, multidimensional, one-perspective, multi-perspective, high resolution parameter types of information or any combination thereof.

19. The system of claim 1, adapted for use by a remote user.

20. The system of claim 1, adapted to function on a real time basis.

21. The system of claim 1, adapted to function on retrospective basis.

22. The system of claim 1, adapted to function interactively.

23. A method for assessing the performance and outcome of a health care service provider, the method comprising:
providing health care related data, wherein the data comprises data collected from a production floor of a health care service provider;
performing linearization of at least a section of the data collected from the production floor by using a filter system; and
producing information according to selected criteria.

24. The method of claim 23, wherein said database comprises, clinical data, financial data, data relating to service, logistical data, data relating to human resources, administrative data, sanitation data or any combination thereof.

25. The method of claim 23, wherein said linearization comprises generation of a clinical identity of a patient, performance information, process information, outcome information or any combination thereof.

26. The method of claim 23, wherein said linearization comprises evaluation of the correlation, association, relationship or any combination thereof between and/or within any of the components of the production floor.

27. The method of claim 23, wherein said linearization is associated with at least at a part the health care related data.

28. The method of claim 23, further comprising performing an analysis of at least a section of the linearized data.

29. The method of claim 28, further comprising performing an analysis of at least a section of the linearized data in combination with at least a section of the health care related data.

30. The method of claim 28, wherein said analysis is performed within and/or between one-dimensional, multidimensional, one-perspective, multi-perspective, high resolution parameters or any combination thereof.

31. The method of claim 28, wherein said analysis comprises analysis of clinical data.

32. The method of claim 28, wherein said analysis further comprises analysis and integration of financial data, data relating to service, logistical data, data relating to human resources, administrative data, sanitation data or any combination thereof.

33. The method of claim 23, wherein said analysis comprises a cause-effect analysis.

34. The method of claim 23, wherein said analysis comprises analysis of clinical process applied to patients with similar clinical identities.

35. The method of claim 23, further comprising producing a response to a query.

36. The method of claim 23, further comprising performing a simulation for a selected scenario.

37. The method of claim 36, wherein said scenario comprises a clinical, economical, service scenario or any combination thereof.

38. The method of claim 23, further comprising evaluating current performance, current outcome, former performance, former outcome or any combination thereof.

39. The method of claim 38, wherein evaluating performance comprises evaluating a patient's clinical process.

40. The method of claim 23, further comprising performing a prediction of future performance, future outcome or both.

41. The method of claim 23, wherein said filter system comprises a one-dimensional, multidimensional, one-perspective, multi-perspective, high-resolution parameter filter or any combination thereof.

42. The method of claim 23, wherein said information comprises a one-dimensional, multidimensional, one-perspective, multi-perspective, high resolution parameter types of information or any combination thereof.

43. The method of claim 23, further comprising updating the health care-related data.

44. The method of claim 23, further comprising calibrating, scaling, normalization or any combination thereof of the health care-related data.

45. The method of claim 23, further comprising producing a report, wherein the report includes at least a part of the information.
